(19) United States
(12) Patent Application Publication
(10) Pub. No.: US 2009/0309542 A1
(43) Pub. Date: Dec. 17, 2009

(54) Multi-input charger

(76) Inventors: Huang-Chiang Hung, Kaohsiung (TW); Chang-Ning Hung, Kaohsiung (TW)

Correspondence Address: BACON & THOMAS, PLLC, 625 SLATERS LANE, FOURTH FLOOR, ALEXANDRIA, VA, 22314-1176, US

(21) Appl. No.: 12/213,251

(22) Filed: Jun. 17, 2008

(51) Int. Cl. H02J 7/02

(52) U.S. Cl. 320/111

(57) ABSTRACT

A charger has a converter, a cigarette lighter adapter and a charger plug. The converter converts AC power to DC power and regulates a voltage range of the DC power to an appropriate range for charging portable electronic devices such as cell and smart phones and the like and has an output port and a plug. The cigarette lighter adapter has a cord extending from the cigarette lighter adapter and being electrically connected to the converter. The charger plug is detachably connected to the converter and has a cord extending from the charger plug and a connector being formed on the cord, corresponding to and being selectively mounted in the output port or in a socket of a computer. Therefore, a user can charge portable electronic devices in an automobile, electric socket or computer without carrying different chargers.

### BACKGROUND OF THE INVENTION

1. Field of the Invention

The present invention relates to a charger, especially to a multi-input charger capable being between an automobile, an indoor socket or a computer and a portable device to charge the latter.

2. Description of the Related Art

A portable device, such as but not limited to a personal digital assistance (PDA), cell phone, MP3/MP4 player, smart-phone, I-Pod or the like has a rechargeable battery mounted inside to supply operating power. For convenience, a user may connect a charger adapted to connect to and charge the portable device without removing the battery.

With reference to FIG. 5, a conventional charger has a converter (40) and a charger plug (41). The converter (40) has a plug (400) for inserting into an indoor socket and converts an AC power into a DC power and may transform the voltage. The charger plug (41) is electrically connected to the converter (40) via a cord (401) and outputs the DC power to a mobile phone.

With further reference to FIG. 6, another conventional charger for using in an automobile has a cigarette lighter adapter (50) and a charger plug (51). The cigarette lighter adapter (50) corresponds to and is inserted into an electric cigarette lighter socket of an automobile to output a DC power source from the automobile. The charger plug (51) electrically connects to the cigarette lighter adapter (50) via a cord (500) and outputs the DC power source to charge a mobile phone.

However, each of the conventional chargers is a one-piece device, and is inconvenient to carry different kinds of chargers for charging the mobile phone when going out for a trip. Furthermore, chargers may not be carried day-to-day but is required and not available causing inconvenience to the user.

To overcome the shortcomings, the present invention provides a multi-input charger to mitigate or obviate the aforementioned problems.

### SUMMARY OF THE INVENTION

The main objective of the invention is to provide a charger that allows users to charge their mobile phones from an automobile, an indoor socket or a computer.

To achieve objective, the charger comprises a converter, a cigarette lighter adapter and a charger plug. The converter converts AC power to DC power and regulates a voltage range of the DC power to an appropriate range for charging portable electronic devices such as cell and smart phones and the like and has an output port and a plug. The cigarette lighter adapter has a cord extending from an end of the cigarette lighter adapter and being electrically connected to the converter. The charger plug is detachably connected to the converter and has a cord extending from an end of the charger plug and a connector being formed on the cord. The connector corresponds to and is selectively mounted in the output port of the converter or socket of a computer. Therefore, a user can charge portable electronic devices in an automobile, electric socket or computer without carrying different chargers.

Other objectives, advantages and novel features of the invention will become more apparent from the following detailed description when taken in conjunction with the accompanying drawings.

### BRIEF DESCRIPTION OF THE DRAWINGS

FIG. 1 is perspective view of a first embodiment of a charger in accordance with the present invention;

FIG. 2 is a schematic view of the charger in FIG. 1 showing various operating modes of the charger;

FIG. 3 is a circuit diagram of a converter in accordance with the present invention;

FIG. 4 is a perspective view of a second embodiment of a charger in accordance with the present invention;

FIG. 5 is a perspective view of a conventional charger; and

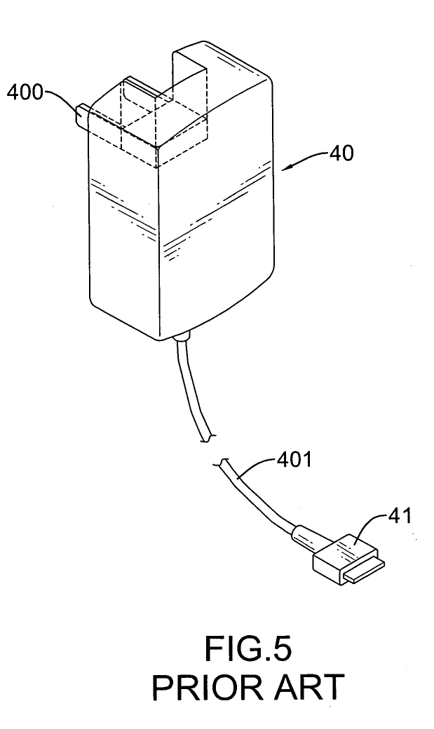

FIG. 6 is a perspective view of another conventional charger.

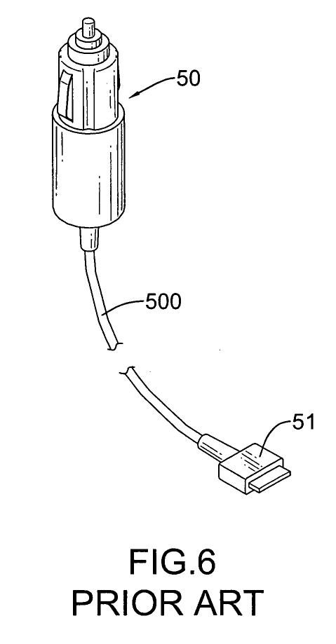

### DETAILED DESCRIPTION OF THE PREFERRED EMBODIMENTS

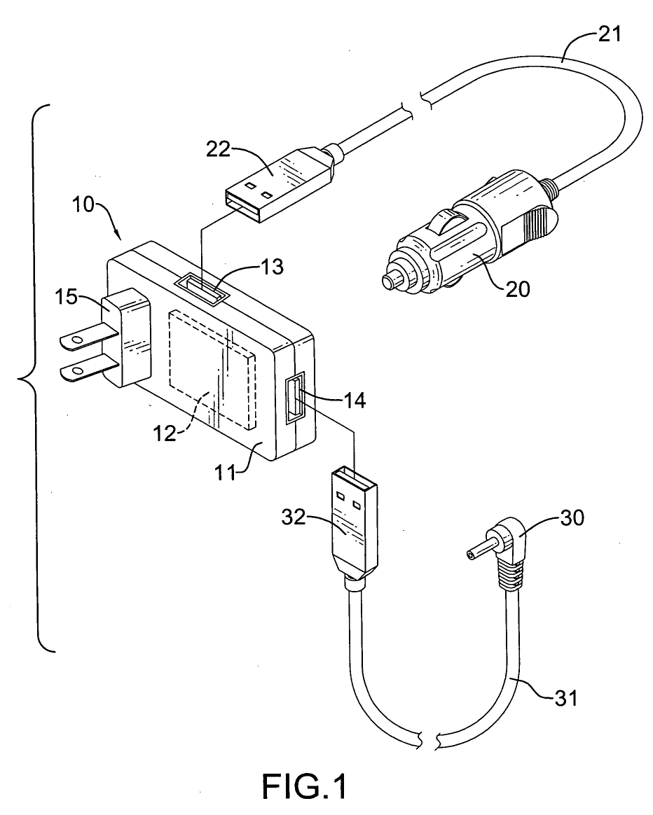

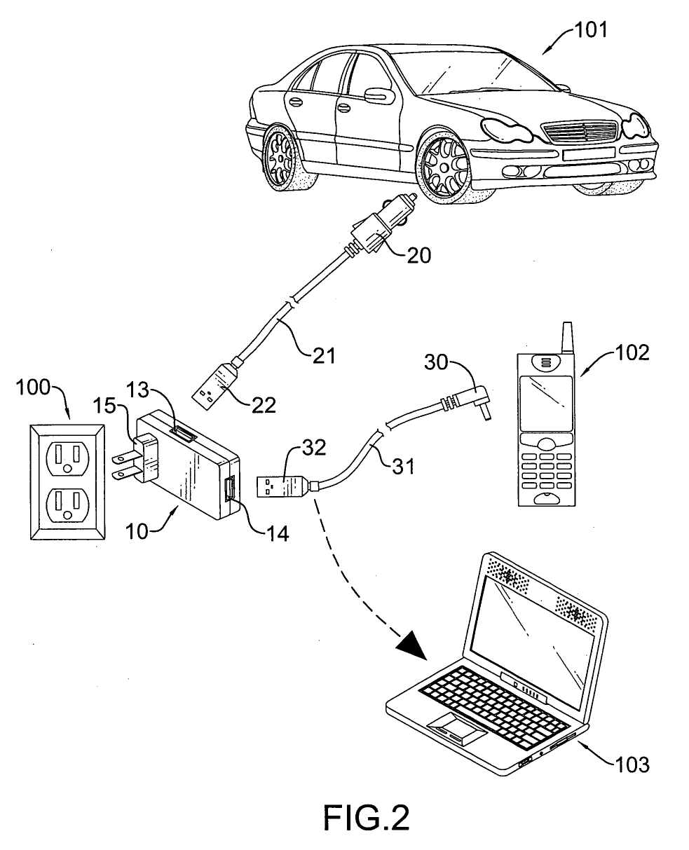

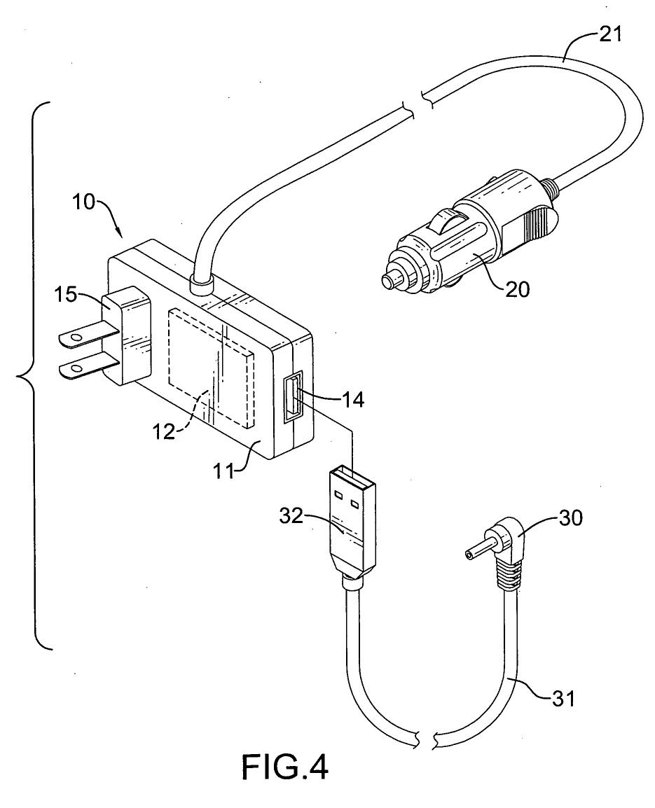

With reference to FIGS. 1, 2 and 4, a charger in accordance with the present invention comprises a converter (10), a cigarette lighter adapter (20) and a charger plug (30).

The converter (10) has a case (11), a circuit board (12), an optional input port (13), an output port (14) and a plug (15). The circuit board (12) is mounted inside the case (10) and converts AC power to DC power and regulates the voltage range of the DC power to an appropriate range for charging mobile phones. The input and output ports (13, 14) are mounted through the case (11) and are connected to the circuit board (12) and may be implemented as USB ports or the like. The plug (15) corresponds to an electric socket (100) and may be two-pin or three-pin type and is mounted on and protrudes out from the case (11) and is electrically connected to the circuit board (12).

The cigarette lighter adapter (20) corresponds to and is inserted into an electric cigarette lighter socket of an automobile (101), is attached to the converter (10), may be detachably connected to the converter (10) using an optional connector (22) and has a cord (21). The cord (21) extends from the cigarette lighter adapter (20) and may be mounted through the case (11) and may be electrically connected to the circuit board (12). The connector (22) is formed on the cord (21), corresponds to and detachably mounted in the input port (13) and may be implemented as a USB plug or the like.

The charger plug (30) is for inserting into a charger socket of a portable device such as a cell phone (102), is detachably connected to the converter (10) and has an end, a cord (31) and a connector (32). The cord (21) extends from the end of the charger plug (30). The connector (32) is formed on the cord (21), corresponds to the output port (14), may be selectively mounted in a computer (103) and may also be implemented as a USB plug or the like.

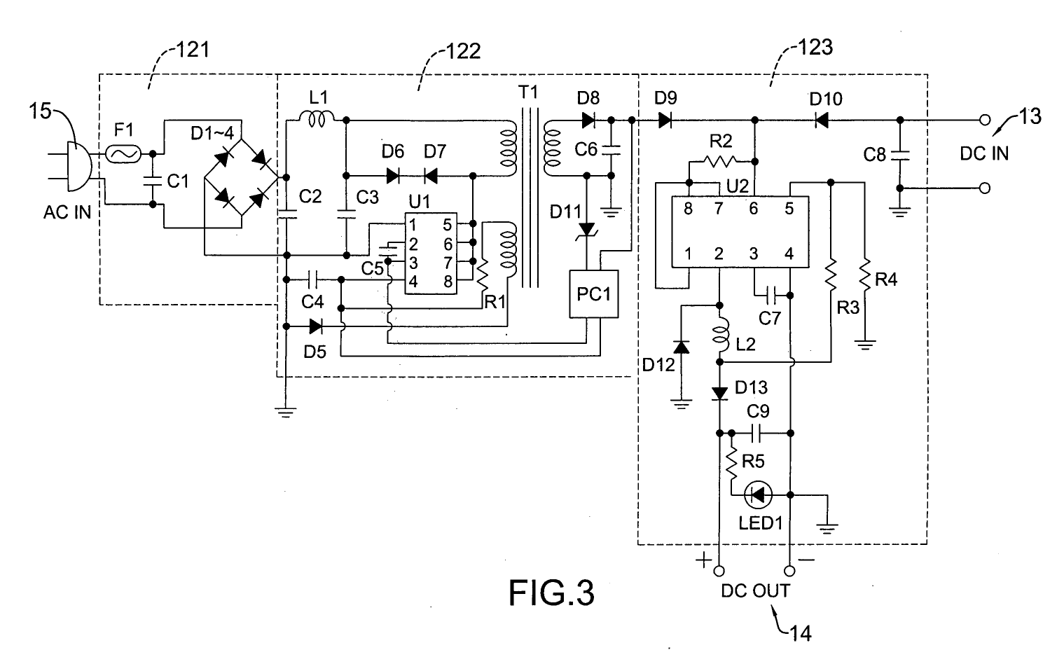

With further reference to FIG. 3, the circuit board (12) of the converter (10) comprises a rectifying unit (121), a voltage-stabilizing unit (122) and a voltage-regulating unit (123).

The rectifying unit (121) is connected to the plug (15) of the converter (10) to convert AC power transmitted from the plug (15) to DC power and the rectifying unit (121) has a capacitor (C1) and a bridge rectifier (D1˜D4).

The voltage-stabilizing unit (122) is connected to the rectifying unit (121) to stabilize the DC power output from the rectifying unit (121) by regulated voltage levels and has a transformer (T1), a controller (U1) and a photo coupler (PC1).

The voltage-regulating unit (123) is connected to the voltage-stabilizing unit (122), the input port (13) and the output port (14) and may include at least one LED (LED1). The voltage-regulating unit (123) regulates a voltage range of the DC power transmitted from the voltage-regulating unit (122) or the input port (13) being connected to the electric cigarette lighter adapter (20) to an appropriate voltage range between 3.5 volts to 7 volts and outputs the DC power to the output port (14) for charging the portable device being connected to the output port (14) through a regulator (U2). The at least one LED (LED1) is connected between two output pins of the regulator (U2) to indicate a working status of the charger.

When the charger plug (30) of the charger is plugged into a portable device such as the cell phone (102), the cell phone (102) is charged safely by the cigarette lighter adapter (20) through the converter (10) in an automobile (101) or by the electric socket (100) through the plug (15) of the converter (10). Furthermore, the connector (32) of the charger plug (30) may be connected to a socket of a computer (103) to charge the cell phone (102) when using the computer (103) and possibly transferring data therebetween. Therefore, the charger allows safe charging of portable electronic devices while mobile or stationary through the electric cigarette lighter, electric socket or through a portable or desktop computer; thereby ensuring the device is safely charged for convenience and security and a single unit is required so multiple leads for different applications are not forgotten or carried.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A charger comprising:
a converter having
a case;
a circuit board being mounted inside the case;
an output port being mounted through the case and connected to the circuit board; and
a plug being mounted on and protruding out from the case and being electrically connected to the circuit board;
a cigarette lighter adapter being attached to the converter and having a cord extending from the end of the cigarette lighter adapter; and
a charger plug being detachably connected to the converter and having
a cord extending from the charger plug; and
a connector being formed on the cord of the charger plug and corresponding to the output port.

2. The charger as claimed in claim 1, wherein
the cord of the cigarette lighter adapter is mounted through the case and is electrically connected to the circuit board;
the output port is a USB port; and
the connector of the charger plug is a USB plug.

3. The charger as claimed in claim 1, wherein the circuit board of the converter further comprises:
a rectifying unit being connected to the plug of the converter to convert AC power transmitted from the plug to DC power and having a capacitor and a bridge rectifier;
a voltage-stabilizing unit being connected to the rectifying unit to stabilize the DC power output from the rectifying unit and having a transformer, a controller and a photo coupler; and
a voltage-regulating unit being connected to the voltage-stabilizing unit, the cigarette lighter adapter and the output port of the converter to regulate a voltage range of the DC power transmitted from the voltage-regulating unit or the cigarette lighter adapter to an appropriate voltage range and having a regulator for outputting the DC power to the output port.

4. The charger as claimed in claim 3, wherein the voltage-regulating unit further has at least one LED being connected between two output pins of the regulator to indicate a working status of the charger.

5. The charger as claimed in claim 1, wherein
the converter further comprises an input port being mounted through the case and connected to the circuit board; and
the cigarette light adapter further comprises a connector being formed on the cord of the cigarette light adapter, corresponding to and detachably mounted in the input port.

6. The charger as claimed in claim 5, wherein the output port and input port are USB ports and the connector of the charger plug and cigarette lighter adapter are USB plugs.

7. The charger as claimed in claim 5, wherein the circuit board of the converter further comprises:
a rectifying unit being connected to the plug of the converter to convert AC power transmitted from the plug to DC power and having a capacitor and a bridge rectifier;
a voltage-stabilizing unit being connected to the rectifying unit to stabilize the DC power output from the rectifying unit and having a transformer, a controller and a photo coupler; and
a voltage-regulating unit being connected to the voltage-stabilizing unit, the input port and the output port of the converter to regulate a voltage range of the DC power transmitted from the voltage-regulating unit or the input port to an appropriate voltage range and having a regulator for outputting the DC power to the output port.

8. The charger as claimed in claim 7, wherein the voltage-regulating unit further has at least one LED being connected between two output pins of the regulator to indicate a working status of the charger.
